(19) United States
(12) Patent Application Publication
(10) Pub. No.: US 2011/0087471 A1
(43) Pub. Date: Apr. 14, 2011

(54) Methods and Systems For Determining Near-Wellbore Characteristics and Reservoir Properties

(75) Inventors: Dieter Postl, Manvel, TX (US); Jason A. Burdette, Houston, TX (US); Jim H. Lee, Houston, TX (US); Timothy G. Benish, Pearland, TX (US); Bruce A. Dale, Sugar Land, TX (US)

(73) Assignee: EXXONMOBIL UPSTREAM RESEARCH COMPANY

(21) Appl. No.: 12/742,496

(22) PCT Filed: Nov. 3, 2008
(86) PCT No.: PCT/US08/82249

§ 371 Date: May 12, 2010

Related U.S. Application Data
(60) Provisional application No. 61/009,622, filed on Dec. 31, 2007.

(51) Int. Cl. G06F 17/11; G06G 7/48

(52) U.S. Cl. 703/2; 703/10

(57) ABSTRACT

Systems and methods are provided for determining a reservoir property distinct from a near-wellbore/completion characteristic. The methods include obtaining non-transient well data regarding a measurable characteristic of a well that is used to establish a functional relationship between a reservoir property, a near-wellbore/completion characteristic, and the measurable characteristic of the well. A model that relates the reservoir property and the near-wellbore/completion characteristic is used to generate a modeled near-wellbore/completion characteristic value from an input reservoir property value, or vice versa. The input value and the modeled value are then tested against the well data using the functional relationship. The model is used repeatedly with different input values until a validated reservoir property value and a validated near-wellbore/completion characteristic value are identified that at least substantially satisfy the functional relationship. The validated reservoir property value and the validated near-wellbore/completion characteristic are reported for use in business decisions regarding one or more wells.

### CROSS REFERENCE TO RELATED APPLICATIONS

This application claims the benefit of U.S. Provisional Application No. 61/009,622, filed 31 Dec. 2007.

### FIELD

The present disclosure relates to systems and methods for determining the near-wellbore characteristics of a well drilled into a formation and the reservoir properties of a reservoir associated with the formation and the well. More specifically, the systems and methods herein determine the near-wellbore characteristics distinct from the reservoir properties such that each can be used separately and/or together in making decisions regarding production from and/or injection into the well.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

While hydrocarbons have been recovered from formations for centuries, the technology that facilitates and enables such recovery is still evolving. While it was historically possible to recover hydrocarbons by simply drilling a hole in the ground near a reservoir, such easy recoveries are very rare today. As the demand for hydrocarbons continues, efforts to recover hydrocarbons from formations have become ever more challenging. Various factors contribute to the complexity of the efforts to produce hydrocarbons, including such factors as the remoteness of the formations, the depth of the reservoir below the surface, the depth of the water above the reservoir, and the characteristics of the formation(s) associated with the reservoir, among others. Despite the increasing complexity in finding and producing hydrocarbons from these reservoirs, continual advances in technology have made such hydrocarbon production possible, even from reservoirs once believed to be unreachable.

One area in which technological advances have aided in the recovery of hydrocarbons from reservoirs is in the improved ability to determine properties of the formation and the reservoir to design drilling operations, completion operations, production operations, and workover operations to maximize recoveries from a given reservoir. Examples of such applications are plentiful and readily recognized by those in the industry. As one example of such applications, various efforts have been made, to varying degrees of success, to predict the productivity of a well, to monitor the productivity of the well, and to treat the well when the monitored productivity falls sufficiently below the predicted productivity of the well. Various treatments may be available depending on the nature of the reservoir, the formation, and the proximity of other wells. Regardless of the treatment method implemented, the treatments are expensive in themselves and time-consuming as well, further increasing the costs due to lost production during the treatments. Accordingly, such treatments, or workovers, are preferably avoided. And when implemented, determining the proper timing and method of treatment is critical to its success. The selection of the most appropriate treatment operation is often highly dependent on the properties of the reservoir and/or the wellbore.

While the utility of having accurate measurements and/or predictions of wellbore and reservoir properties is well-recognized, prior methods of determining such properties may not have provided operators with the level of detail desired in designing drilling, production, and/or workover operations. For example, some conventional approaches to the problem of reservoir and wellbore characterization from measured data used production log data to estimate reservoir pressure and productivity. In such approaches, the estimated productivity parameter is a “lumped” parameter that generally reflects the combined influences of reservoir properties, completion geometry, near-wellbore damage and/or stimulation, and other properties/factors that influence well performance. As such, these approaches do not provide an operator with knowledge of the near-well/completion characteristics distinct from the reservoir properties, as may be desired in planning stimulation treatments, among other operations.

In other conventional applications, transient pressure build-up tests were conducted on wells to enable an analysis that would yield a distinct permeability parameter and a distinct skin factor. These transient pressure build-up tests are well known in the industry. Common elements of these tests are that the well is taken out of production and shut-in for a period of time while the pressure build-up is monitored. The data collected during the pressure build-up can then be analyzed to deconvolve the lumped productivity factor into a distinct permeability parameter and a distinct skin factor. While this method provides an operator with these desired characteristics about the well, such methods are time-consuming and therefore costly to the well operator as the well is off production for the duration of the build-up test. Moreover, as multi-zone wells are becoming more common, the conventional pressure build-up tests are considered by many to be less applicable for their inability to distinguish between the multiple zones. One method of adapting the pressure build-up tests for multi-zone wells has been proposed including sequentially isolating each of the zones and testing each zone separately. To the extent that build-up tests are inherently slow and correspondingly time consuming, performing multiple build-up tests to test each of the multiple zones is more time-consuming and costly. In certain regions, multi-zone wells can have more than twenty zones rendering repetitive build-up tests impractical.

Moreover, the problems of determining reservoir properties and wellbore characteristics become even more complex in modern wells having multiple intervals, or producing layers, within the reservoir. It is not uncommon for formations to be stratified including different types of rock formations or rock formations having different properties. For example, a highly permeable layer of rock may be disposed above or below a layer of reduced permeability. Most conventional approaches to characterizing wellbores and reservoirs were not able to distinguish between the various layers that may intersect the wellbore and the productivity was determined for the entire wellbore.

More recently developed conventional approaches, such as the method disclosed in U.S. Pat. No. 7,089,167, combine historical production data measured at the well head with production log data to determine the contributions of the distinct layers within the well and to describe individual zone production histories for comingled (or multi-zone/layered) wells. The individual histories are then evaluated as simple draw-down transients to obtain estimates of various parameters. The '167 patent asserts to be able to estimate distinct parameters for each layer, including reservoir properties and near-wellbore/completion characteristics, by using this historical data. However, the methods of the '167 patent requires the use of historical production data that may take days, weeks, or months to develop. The '167 patent discusses how the estimates will be inaccurate if insufficient data points are used suggesting that a relatively large number of historical production logs are used. In some implementations, this historical data may be available to aid operators in estimating reservoir properties distinct from near-wellbore/completion characteristics for multi-zone wells. However, there are many times when the historical data is not available, such as when a well is first completed or after a workover has changed the nature of the well/completion such that the historical data is not relevant. Additionally, the historical data collection methods of the '167 patent fail to allow an estimate of the reservoir properties or the near-wellbore/completion characteristics at a particular time in the life of the well.

While conventional methods provide substantial information about a reservoir and have facilitated the production of hydrocarbons and the use of injection wells, there are several shortcomings still to be addressed. For example, the conventional methods have been unable to reliably distinguish between reservoir properties and near-wellbore/completion characteristics without relying on time-consuming build-up tests or historical production data. Such distinctions may be valuable in a variety of operational decisions regarding a given well, including as examples determining when a workover or treatment is appropriate, determining where a workover or treatment is needed and/or appropriate, determining what type of workover or treatment to apply, and/or determining whether any one or more types of treatments or workovers is economically viable.

### SUMMARY

The present disclosure provides methods and systems for providing more detailed information about a reservoir and an associated wellbore. The methods and systems provide the more detailed information by separating reservoir properties from wellbore characteristics, or more particularly, characteristics of the near-wellbore and/or completion. Additionally, in some implementations, the methods and systems of the present disclosure are able to provide this more detailed information on a layer-by-layer basis. This summary provides an overview of some aspects of the present disclosure and is not intended to be a full or complete description of the invention(s) disclosed herein and should not be read to limit any one or more of the invention(s) described herein.

In some implementations of the present methods, the methods include obtaining non-transient well data regarding at least one measurable characteristic of a well and establishing a functional relationship between a reservoir property, a near-wellbore/completion characteristic, and at least one measurable characteristic of the well. For example, the reservoir property may be or include the reservoir permeability and the near-wellbore/completion characteristic may be or include the skin factor. The methods further include accessing a model that relates the reservoir property and the near-wellbore/completion characteristic.

The method then utilizes the model with a selected value for one of the reservoir property or the near-wellbore/completion characteristic to generate a corresponding modeled value for the other of the reservoir property or the near-wellbore/completion characteristic. For example, if the selected value is a reservoir property, the model would generate a corresponding modeled value for the near-wellbore/completion characteristic. Continuing with the non-limiting examples of reservoir properties and near-wellbore/completion characteristics, the selected value utilized in the model may be a selected permeability value and the modeled value may be a modeled skin factor value.

The selected value and the corresponding modeled value are then tested against the obtained well data using the established functional relationship. The step of utilizing the model with a selected value to generate a modeled value is repeated along with the step of testing the selected value and the modeled value against the well data until the selected and modeled values are validated. The validated reservoir property value and the validated near-wellbore/completion characteristic are then reported for use in business decisions regarding one or more wells.

In some implementations, the methods may be utilized in a well having a reservoir and/or an interval comprising two or more layers. In such implementations, a functional relationship may be established for each of the layers and the steps of utilizing the model and testing the values against the well data may be repeated for each of the layers to enable reporting on a layer-by-layer basis.

### BRIEF DESCRIPTION OF THE DRAWINGS

The foregoing and other advantages of the present technique may become apparent upon reading the following detailed description and upon reference to the drawings in which:

FIG. 1 illustrates a schematic view of a wellbore extending into a formation together with associated equipment;

FIG. 2 provides a schematic view of a reservoir and the wellbore from FIG. 1;

FIG. 3 provides a schematic view of a wellbore extending into a reservoir having multiple producing intervals;

FIG. 4 provides a flow chart representative of methods described herein;

FIG. 5 provides another flow chart representative of methods described herein;

FIG. 6 provides a representative graph illustrating aspects of the present methods;

FIG. 7 provides another flow chart representative of methods described herein; and

FIG. 8 provides another flow chart representative of methods described herein.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments described below, but rather, the invention includes all alternatives, modifications, and equivalents falling within the scope of the appended claims.

As will be better understood by the description that follows and the associated figures, the present disclosure includes systems and methods that can be used to determine reservoir properties distinct from near-wellbore/completion characteristics without the use of transient data. While distinctly determining such properties and characteristics is conventionally done using transient data, the use of transient data adds costs and complexity to operations, as described above. The systems and methods of the present disclosure utilize non-transient data, or data taken at particular point(s) in time, rather than transient data collected over time. Such distinct determinations may be used in a variety of manners and in a variety of types of wells. For example, the reservoir properties and the near-wellbore/completion characteristics may be used in planning production operations, treatment operations, workover operations, etc. As further examples of the potential use of such determinations, the reservoir properties and the near-wellbore/completion characteristics may be useful in decisions related to both production wells and injection wells. Other useful applications of the reservoir properties and the near-wellbore/completion characteristics determined by the present systems and methods will be readily understood by those of ordinary skill.

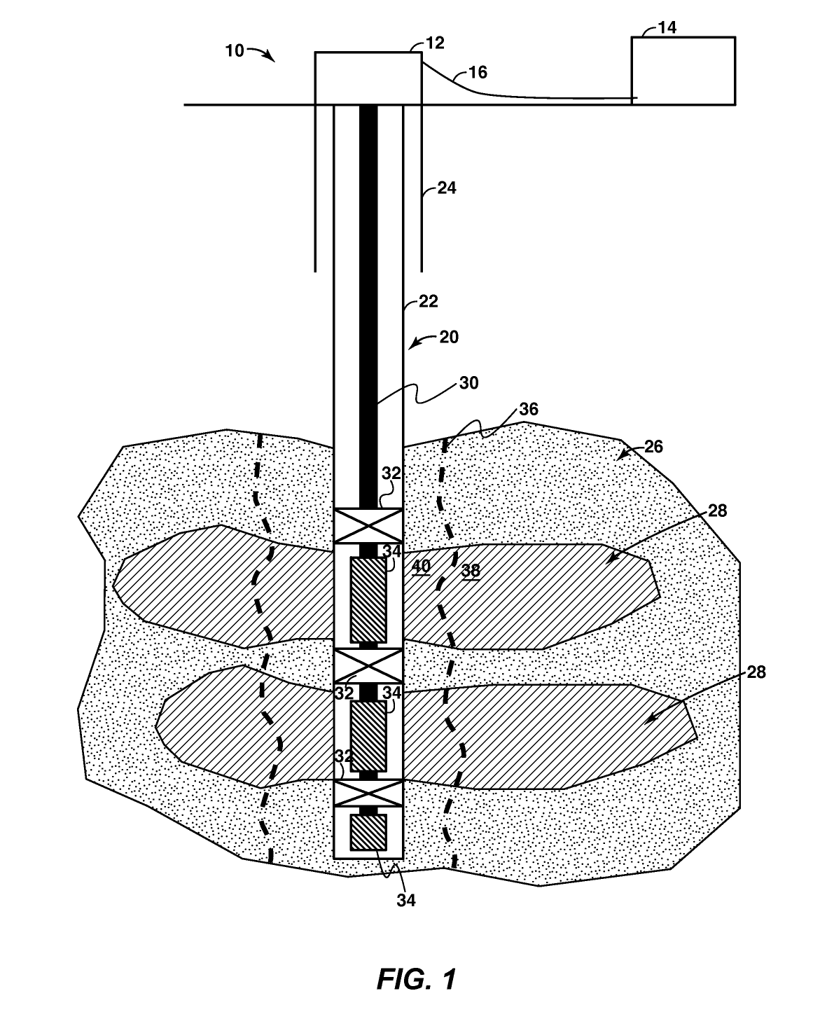

FIG. 1 illustrates one context in which the present systems and methods may be utilized. While FIG. 1 illustrates a schematic view of a land-based, vertical well 10, the present methods and systems also have utility in offshore wells as well as directional wells, horizontal wells, etc. While particular equipment is schematically illustrated and generally described in connection with the present systems and methods, the field equipment used in a given implementation may depend on the circumstances of the given well, such as its location, environment, geological characteristics, etc.

The well 10 of FIG. 1 is schematically illustrated as including a conventional tree 12 and a production facility 14, which are connected by one or more communication lines 16. As will be understood, communication lines 16 may include pipes, tubes, cables, or other types of lines for communicating fluids, data, etc, between the tree 12 and the production facility 14. The tree 12 and the production facility 14 are merely representative of the variety of equipment and instruments that may be used in association with the well 10. Beneath the surface 13 illustrated in FIG. 1, the well 10 includes a wellbore 20. Wellbore 20 may be cased or uncased, or may include both cased and uncased lengths; the schematic illustration of FIG. 1 illustrates a wellbore wall 22 representative of both cased and uncased wellbore peripheries. FIG. 1 also illustrates surface casing 24 associated with the tree 12 and the uppermost sections of the wellbore.

The wellbore 20 of FIG. 1 extends from the surface 13 into the formation 26 and through reservoirs 28. Various equipment and tools are schematically illustrated inside the wellbore 20 of FIG. 1. The illustrated equipment is representative of the variety of equipment that may be positioned in the wellbore. As illustrated, the equipment in the wellbore 20 includes production tubing 30, packers 32, and production tools 34. In other implementations, the production tubing 30 may be replaced by injection tubing or other suitable equipment. Representative production tools 34 that may be utilized in the wellbore 20 include sand control tools, water control tools, flow rate control tools, monitoring tools, etc. Again, any variety of tools may be used downhole in wells with which the present methods and systems may be utilized.

As mentioned, the wellbore 20 extends into a formation 26 and through reservoirs 28. It is not uncommon in modern drilling operations for a single wellbore to connect multiple reservoirs 28, such as illustrated schematically in FIG. 1. The presence of multiple reservoirs 28 associated with a single wellbore complicates many wellbore operations, including the production from the wellbore and the maintenance of the wellbore. For example, certain operations that may be good for one reservoir may be detrimental to the other reservoir. In many implementations, packers 32 or other equipment can be disposed in the wellbore to isolate the reservoirs from each other, such as shown in FIG. 1. However, such mechanical isolation techniques may not be economically or technically available in every circumstance or may not yet be implemented when decisions need to be made that would be better informed with details regarding the reservoir properties and the near-wellbore/completion characteristics. Accordingly, some multi-reservoir wellbores may not isolate the reservoirs from each other.

FIG. 1 further illustrates via vertical hash lines a boundary 36 between what is referred to herein as the reservoir region 38 and what is referred to herein as the near-wellbore/completion region 40. Boundary 36 is illustrated as an irregular, curved line suggestive that the reservoir region 38 and the near-wellbore/completion region 40 are not finely divided by an actual boundary. However, as is well understood, there is a difference between the properties of the formation and reservoir near to the wellbore and the properties of the formation and reservoir far from the wellbore. The differences may be attributed to any of a variety of factors, some of which may include changes in the nature of the formation and reservoir that occurred during drilling, completion, and/or production operations. For example, drilling mud and/or completion fluids may have permeated into the formation/reservoir near to the wellbore affecting the natural permeability of the formation/reservoir. The size, shape, and character of the near-wellbore/completion region will be dependent on the operations previously conducted in the wellbore and on the natural properties of the formation/reservoir. Accordingly, the boundary 36 merely highlights that there is a difference between the properties of the reservoir far from the wellbore and the properties of the reservoir near to the wellbore. As used herein, the term reservoir properties is used to refer to the properties of the reservoir in the reservoir region 38 and the term near-wellbore/completion characteristics is used to refer to the properties of the reservoir in the near-wellbore/completion region 40.

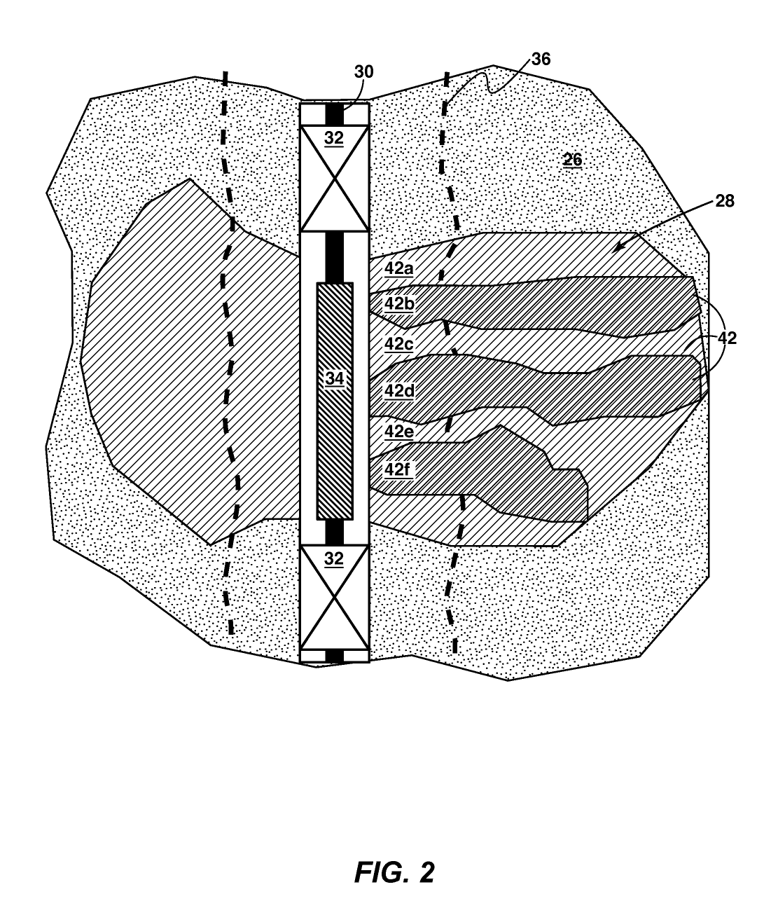

FIG. 2 illustrates another schematic view of the well 10 from FIG. 1. The schematic view of FIG. 2 is zoomed in on one of the reservoirs 28 in the formation 26 revealing (schematically) that reservoirs 28 may comprise more than one geologic formation causing the reservoir to have multiple layers or intervals 42, illustrated in FIG. 2 as intervals 42a, 42b, 42c, etc. In some implementations, each of the intervals 42 may be producing intervals that produce at different rates and/or differently in some other manner. In other implementations, reservoirs 28 may include non-producing intervals, such as layers that are sufficiently small to indicate that it is merely an anomaly within a reservoir rather than a non-producing formation disposed between distinct reservoirs.

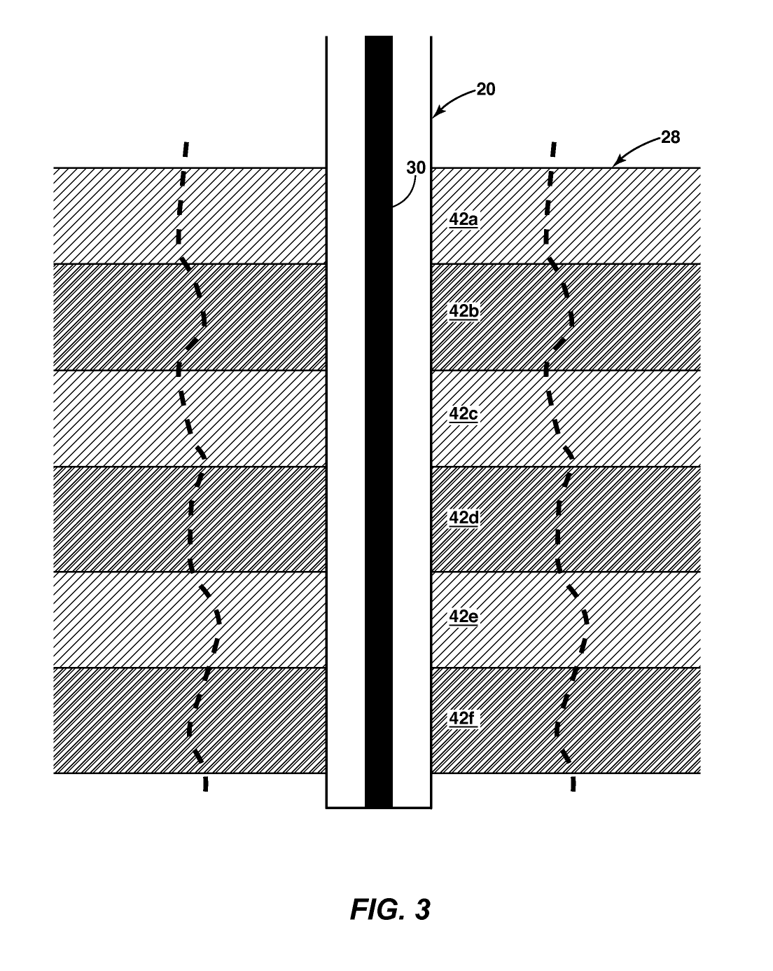

FIG. 3 illustrates yet another schematic view of a wellbore 20 extending through a reservoir 28. FIG. 3 varies from FIGS. 1 and 2 in at least 2 ways. For example, FIG. 3 illustrates that the equipment in the wellbore may vary from that shown in FIGS. 1 and 2. Specifically, it is possible that the production tube 30 can be disposed within the wellbore without auxiliary production tools 34 or with any variation of tools and equipment. Additionally, the schematic representation of the reservoir has been illustrated in a more exaggerated schematic view illustrating the various intervals that may be present in a reservoir as distinct and regularized layers. While the reservoir 28 of FIG. 3 has been simplified for purposes of illustration and discussion herein, the present systems and methods are useful in reservoirs of any configuration, including reservoirs having a uniform configuration and those have highly complex and irregular configurations.

As described above, modern hydrocarbon recovery efforts have included utilizing a single wellbore to access multiple reservoirs and/or reservoirs having multiple intervals of unique character. While such methods can improve the economics of the recovery operations in many ways, the multi-zone wellbores also complicate the recovery operations. One example of the complication lies in the difficulty introduced in operating and/or treating a single wellbore having different properties along its length, such as schematically represented in FIGS. 1-3. Conventional methods often rely upon isolating the various zones during the tests and/or treatment processes. However, in a wellbore having multiple zones, such as five, ten, or more zones, the cost of treating or testing each zone separately can become economically non-viable. For example, well productivity parameters were often determined for the entire wellbore rather than for the individual layers or intervals. Recent advances have assertedly provided a method to determine productivity parameters and even distinct reservoir properties and near-wellbore/completion characteristics on a layer-by-layer basis, but such methods require data from the well that is costly and time consuming to obtain.

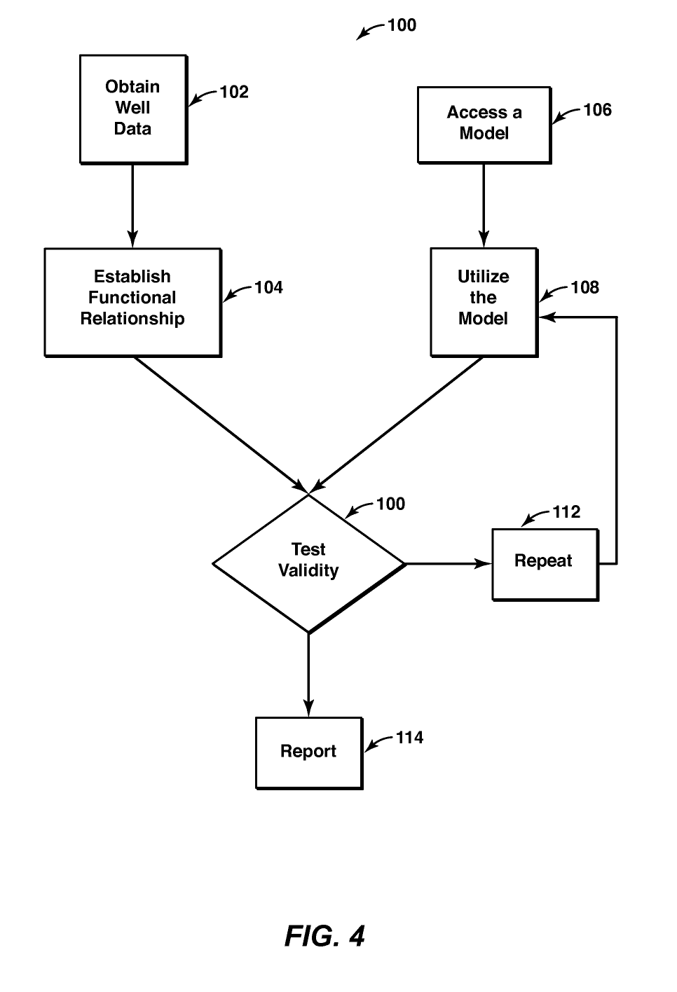

FIG. 4 illustrates a high-level flow chart of methods of the present disclosure, which methods enable the determination of near-wellbore/completion characteristics distinct from reservoir properties. FIGS. 4-7 provide multiple flow charts highlighting aspects of the present invention. While multiple flow charts illustrate some of the variations and implementations of the present technology, the technology is not limited by the representations of the flow charts. As a non-limiting example of variations upon the flow charts presented, any one or more element or step illustrated in connection with a particular flow chart may be implemented in the methods of one or more of the other flow charts.

Returning to FIG. 4, a well characterization method 100 is illustrated. The well characterization method 100 may begin by obtaining well data from a well, at 102. The well data obtained provides information about at least one measurable characteristic of the well. For example, the pressure in the wellbore may be measured at one or more specific points in time, which may include varied measurements of wellbore pressure along the length if there are multiple zones or intervals in the wellbore. The well data may additionally or alternatively include flow rates into the wellbore at one or more specific point(s) in time, which may be inferred flow rate measurements based on other measurable parameters, and which may include multiple flow rate measurements along the length of the wellbore in the event that the reservoir/formation includes multiple zones or intervals. The step of obtaining well data 102 may be accomplished in any suitable manner such as utilizing production logs and/or downhole monitoring systems.

Obtaining well data 102 may be accomplished using production logging tools (PLT), which can provide a variety of data about the well, including pressure, rates, etc. In some implementations, the PLT data may be collected at two well operating conditions, such as under a shut-in condition and at one flowing rate. In other implementations, production logs may be run at multiple rates to facilitate the development of a functional relationship between the various measured parameters and the properties that affect the measured values. The use of PLT data from multiple rates may be preferred when the wellbore connects multiple intervals. In addition to collecting the data from the production logs, some implementations may include the collection of information regarding the sequence of events during the production log test(s), such as the times of the different logging passes relative to the shut-in test.

While the methods of the present disclosure may utilize multiple production logs to obtain well data 102, the data collected does not include transient pressure data. The PLT passes of the present methods collect measurements at a particular point(s) in time rather than over time as in the pressure build-up tests that rely upon transient data. Additionally, the present methods do not rely upon the collection or analysis of historical production data. Accordingly, the methods used to collect or obtain well data 102 of the present methods are faster and available in a broader range of circumstances.

The well characterization method 100 continues by establishing a functional relationship 104 between two or more properties of the well. The functional relationship will relate at least one measured property of the well with at least one near-wellbore/completion characteristic and at least one reservoir property. For example, the measured wellbore pressure(s) and flow rate(s) may be related to the permeability of the reservoir region and the skin factor of the near-wellbore/completion region for the entire well and/or for the individual layers. The functional relationship between the various parameters of the well, including the reservoir region and the near-wellbore/completion region, may be established by utilizing one or more inflow equations.

A variety of inflow equations are known and have been used to model or describe the flow of fluids into wellbores. Any of conventional inflow equations may be used depending on the data observed in the production logging data. For example, the physical measurements of a particular interval may suggest using a particular type of inflow equation. Similarly, trends in the measured data may suggest using a particular inflow equation. Preferably, the inflow equation will be a transient equation to accommodate the reality that the well is not at steady-state during the production logging operations. However, it is to be noted that the transient inflow equations do not require transient data from the well; the use of transient inflow equations enables the selected inflow equation to properly characterize the data from the PLT.

Depending on the inflow equation selected, the functional relationship established by the present method may vary. For example, some wells may be best described by a linear relationship between the measured pressures and flow rates. Other wells may be better described in a quadratic or other type of relationship. Preferably, each of the intervals of the well can be described by a linear relationship having the form of the following equation:

qⱼ=f(kⱼ, Sⱼ, . . . )·ΔPⱼ,

where qⱼ is the flow rate of the interval, LP, is the measured pressure for the interval, and the specific form of f(kⱼ, Sⱼ, . . . ) is given by the selected form of Darcy's Law, which may preferably be a transient form of Darcy's law. A set of equations may be established to describe the functional relationship between pressure and rate for each layer (or interval) along the length of the wellbore. In some implementations, the functional relationship for each layer may be distinct from the other layers or intervals in the well. In other implementations, it may be found that two or more intervals have similar or identical relationships.

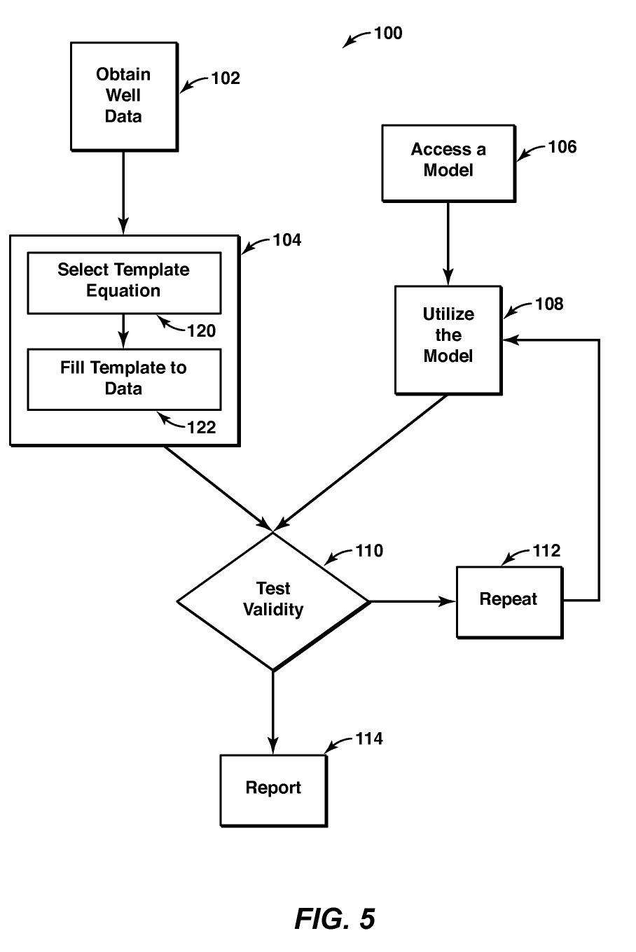

In light of the varied conditions within a wellbore, it may be preferred to select a template inflow equation from the several conventional, known inflow equations followed by customizing the selected question to fit the measured data. These optional steps are illustrated in FIG. 5 as selecting template equation 120 and fitting template to data 122. In addition to, or as an alternative, the methods may similarly include fitting the data or otherwise interpreting the measured data as part of selecting a template equation and/or establishing the functional relationship. In some implementations, for example, it may be found that a particular layer is overspecified, such as by having a larger number of data points than independent variables associated with the functional relationship for a given layer. The overspecification of the layer may be recognized prior to selecting the template equation (or the form of the Darcy equation) such that an inflow equation is selected that can be fit or modified to suit the data.

In the exemplary functional relationship shown in the equation above, the linear relationship between rate and pressure is dependent upon a particular Darcy equation and the variables therein. As illustrated, the inflow equation and functional relationship produce a productivity index (f which depend on parameters such as skin factor (Sⱼ) and permeability (k₁). While the lumped productivity index has its uses, it is often more preferred to know the skin factor distinct from the permeability. The skin factor is one example of a near-wellbore/completion characteristic and the permeability is one example of a reservoir property, each of which may be determined distinct from the other according to the present methods. While the use of functional relationships incorporating Darcy's Law may be used in the present methods to determine skin factor and permeability, the present methods may be adapted to determine other near-wellbore/completion characteristics and reservoir properties.

With continuing reference to FIGS. 4 and 5, it can be seen that the well characterization method 100 also includes accessing a model 106 and utilizing the model 108. In general terms, the model relates the reservoir property (e.g., permeability) and the near-wellbore/completion characteristic (e.g., skin factor). The model is utilized with a selected value to generate a modeled value, the validity of which are then tested, at 110, against the functional relationship. As one illustrative example, the model can be utilized with a selected value for permeability to generate a modeled value for skin factor. The selected and modeled values are then tested against the functional relationship to determine whether the selected and modeled values are valid for the particular interval modeled by the functional relationship. For example, the selected permeability value and the modeled skin factor value are used in the Darcy equation to determine whether the functional relationship equates. If the functional relationship does not equate, the model is utilized again with a different selected value to generate a different modeled value, which are again tested for validity. This process of utilizing the model 108 and testing the validity 110 of the model results is repeated at 112 until the functional relationship and the modeled values equate, or at least substantially equate. These validated results are then reported at 114 for use in business decisions regarding one or more wells. For example, the results can be used to determine whether a treatment of the near-wellbore was successful in improving near-wellbore/completion characteristics. Similarly, the results can be used to determine whether particular treatments will be likely to improve the well's operation.

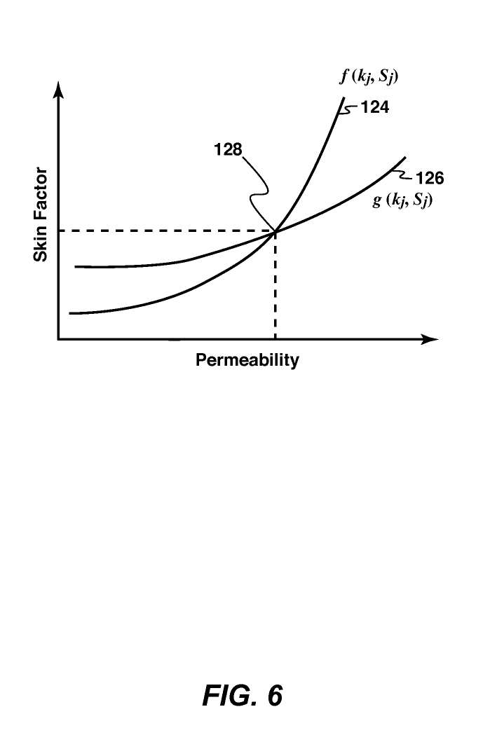

FIG. 6 helps to better illustrate the testing 110 and repeating 112 steps of the present method. As can be seen, FIG. 6 plots the skin factor and the permeability of a single layer of a well. The established functional relationship 124 is shown on the map as f(kⱼ,Sⱼ) while the modeled relationship 126 is shown as g(kⱼ,Sⱼ). With either equation alone, it is impossible to determine the skin factor and permeability value that best reflects the actual well conditions. While the functional relationship is based on the measured data, it is impossible to distinguish between the effects of the skin and the effects of the permeability from the measured data alone. And while the modeled relationship is designed to distinguish between the skin effects and the permeability effects, the model is not constrained by the realities of the well. By testing the modeled values 126 against the functional relationship 124, the combination of modeled skin values and permeability values that satisfy the functional relationship has been found to characterize the skin distinct from the permeability and to do so while minimizing uncertainty. This combination of distinct skin values and permeability values is shown in FIG. 6 at the intersection 128.

Continuing with the exemplary implementation of using the present methods to distinctly determine near-wellbore/completion skin effects and reservoir permeability, the steps of accessing a model 106 and utilizing a model 108 will be described in greater detail. While any suitable model that reliably relates the skin effect and the permeability in a manner that enables the unique determination of each may be used, it may be preferred to utilize a physics-based model. In some implementations, the physics-based model may be a computational model configured such that first principles that impact the response of the modeled system are included in the mathematical model of the system. Depending on the near-wellbore/completion characteristic and reservoir property sought to be distinctly determined and on the completion/workover operation under consideration, the model selected may vary.

The steps of accessing and utilizing a model may be accomplished in any suitable manner. For example, an operator of the present methods may access and utilize a computational model stored or executed on a local computer, a remote computer, or some combination of the two. For example, data may be input into a local computing device. The data may be sent to a remote computing system hosting the model, which may utilize or run the model to produce the results. The results may then be sent back to the local computing device or another location for use. Alternatively, the step of accessing and utilizing the model may be performed in a single location.

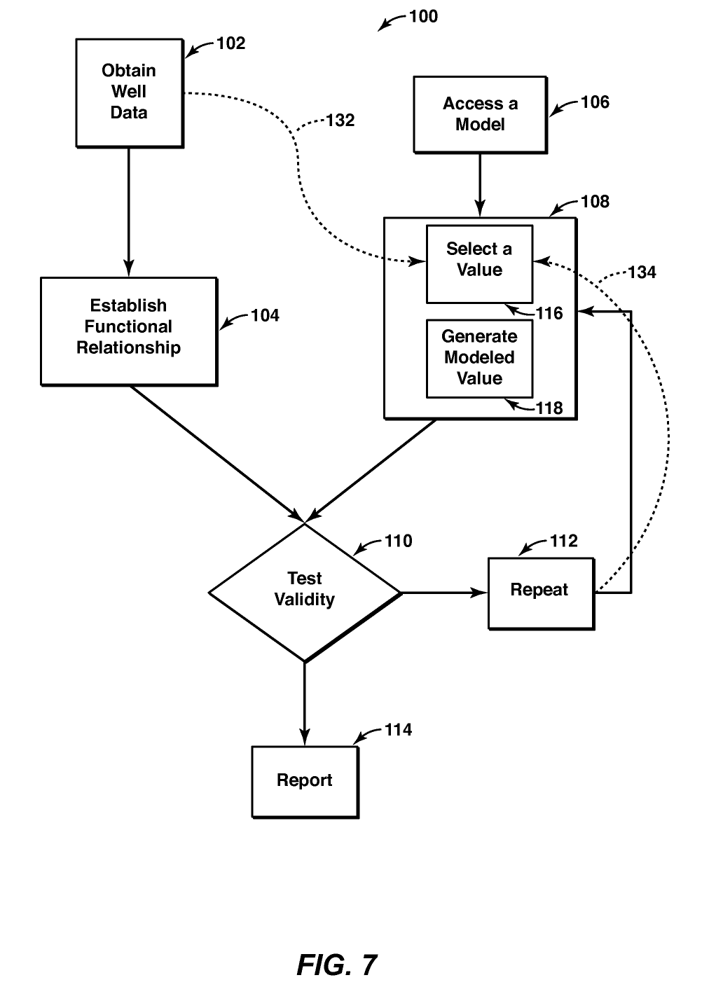

As seen in FIG. 7, the step of utilizing the model 108 may include at least the steps of selecting an initial value 116 and generating a modeled value 118. As suggested by the above discussion, the models utilized in the present methods may generate a modeled value based on an input value. For example, the model may be developed to generate a skin factor based on an input reservoir permeability value, or vice versa. Accordingly, utilizing the model may include the steps of selecting an initial value for one parameter related by the model, and allowing the model to generate another related parameter. In some implementations, utilizing the model 108 may further include inputting other values for the model's use in generating the modeled value. For example, known or measurable values or parameters may be input into the model to further constrain the model to the particular well being analyzed.

In typical implementations of the present methods, the models will be developed to require a single selected value and a single generated modeled value for each layer being analyzed. For example, the model may be adapted to generate a modeled value for a near-wellbore/completion characteristic from an input, selected value for a reservoir property. In some implementations, the models may be sufficiently robust to be utilized in either direction, such that the operator can input either a reservoir property or a near-wellbore/completion characteristic to generate the other. The reservoir permeability and the near-wellbore/completion skin factor are non-limiting examples of parameters that may be utilized in the models within the present methods.

Depending on the model selected or accessed for utilization within the present methods, the selected initial value (such as the selected value for the reservoir property or the near-wellbore/completion characteristic) may be informed by a variety of sources. For example, the selected initial value may be any random number suitable for the parameter being selected, such as a suitable value for skin factor or a suitable value for permeability. An individual utilizing the model may select an initial value based on experience or based on other factors, such as the obtained well data as shown by dashed line 132 in FIG. 7. Exemplary data sources that may inform the selection of an initial value for the selected parameter may include production logs, open hole logs, or other sources common to the industry.

While it is possible that the first selected parameter value will generate a modeled value that, when tested against the functional relationship, prove to be valid (or at least within the desired margin), in many implementations it may be found that an iterative approach may be required to obtain a validated reservoir property value and a near-wellbore/completion characteristic value. With each iteration or repetition of the model utilization, a distinct selected value is input into the model. The selected value input into the model in the subsequent iterations of the model may be informed by or based at least in part on a variety of factors, including the experience of the user, the past selected value(s), the past results of utilizing the model, or some combination of these factors. FIG. 7 illustrates with dashed line 134 that one source of the information upon which the selected value can be based is the results of the past tests for validity of the generated modeled value.

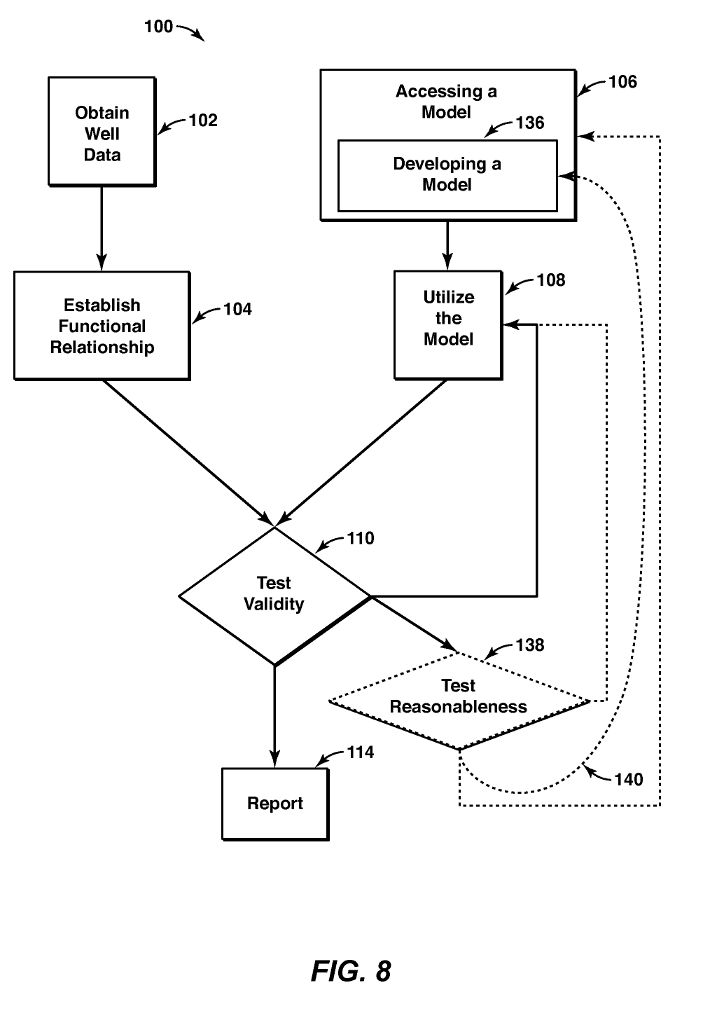

With reference now to FIG. 8, it can be seen that the step of accessing a model 106 may additionally include the step of developing a model 136. As suggested above, the models of the present methods may be any suitable model that enables the generation of a reservoir property (or near-wellbore/completion characteristic) value from the input of a selected near-wellbore/completion characteristic (or reservoir property) value, thereby determining the reservoir property distinct from the near-wellbore/completion characteristic. Exemplary models that may be used include, but are not limited to, analytical models, numerical models, physics-based models, and full physics models that account for all of the first order physics affecting the well.

One exemplary model may be developed by relationships between several equations, some of which may include simplified algorithms obtained from more detailed, first-principles based engineering models. Comprehensive sets of equations have been developed related to carbonate acidizing treatments to provide wormhole length predictions as a function of various stimulation parameters and reservoir properties (such as formation permeability). Examples of these equations can be found in U.S. Pat. No. 6,196,318, the disclosure of which is incorporated herein by reference for all purposes. The equations related to wormhole length prediction can be related to skin factor through finite-element based near-well/completion modeling, for example, to provide a relationship between permeability and skin on a layer by layer basis. This relationship then provides the basis of the model accessed and utilized by the present methods.

The exemplary models developed for use in connection with carbonate acidizing treatments illustrate how other relationships, models, and equations, can be related to provide a model relating a reservoir property and a near-wellbore/completion characteristic and distinguishing between the same. For example, a variety of analytical and/or numerical equations, algorithms, or models may be identified to describe a particular type of completion (e.g., frac pack, gravel pack, etc.) or workover operation (e.g., stimulation treatment). Depending on the particular field application of the present methods, one or more of these equations/models may be coupled with physics-based models or other models or equations to relate the reservoir property and the near-wellbore/completion characteristic as a function of other known or uniquely measurable parameters.

With reference to FIG. 8, it can be seen that the methods of the present disclosure may further include testing the reasonableness 138 of the results. While not required in all implementations of the present methods, it may be preferred to test the results against the experience of the operators or others utilizing the present methods. The reasonableness test may be appropriate after the validity test, particularly when the validity test fails, as illustrated in FIG. 8. To simplify and add clarity to FIG. 8, the repeat steps have been indicated by the straight process flow lines (as compared to the curved line indicating information flow) rather than by the repeat process flow box of the other figures. Accordingly, FIG. 8 illustrates that after the model values are tested against the functional relationship, the process can continue by utilizing the model again 108, by testing the reasonableness of the results 138, or by reporting the results 114. An operator may elect to test the reasonableness of the results for a variety of reasons, including noticing that one or more of the results (either modeled results or the validity tests) not seeming appropriate at first glance, noticing that the repeated validity tests are diverging rather than converging, or that the validated results are impractical. Additionally or alternatively, the methods may include a reasonableness check at one or more steps in the process.

In the illustrated reasonableness test of FIG. 8, the process can continue if the reasonableness is affirmed by repeating the model utilization step 108. Alternatively, FIG. 8 illustrates that a failed reasonableness test 138 may lead to repeating the step of developing a model 136. For example, it may be determined that one or more elements of the model can be refined to improve the results. While not illustrated, the method may also include reconsidering the functional relationship established at 104 or checking any other step in the process. As further illustrated in FIG. 8, the results of the reasonableness test 138 may further inform the process of developing a model (illustrated by curved line 140) and/or establishing a functional relationship.

As suggested above, the present methods may include accessing and utilizing a model in a variety of manners, such as on a local computing device or by utilizing two or more computing devices in communication with each other. The technology of the present disclosure, in addition to the methods described above, includes systems adapted to implement and/or facilitate the implementation of the methods. For example, the repeated utilization of the models may be facilitated by use of a computing device. Accordingly, the systems of the present disclosure may include a processor, a memory coupled to the processor, and an application accessible by the processor. The processor, the memory, and the application need not be hosted by a single device and, depending on the complexity of the models, it may be preferred to have some of the processing distributed across two more computing devices.

The application, whether stored in the memory coupled to the processor or merely stored in memory accessible by processor, may be configured to obtain a functional relationship between reservoir permeability, skin factor, and at least one measurable characteristic of a well and to receive measured data related to the at least one measurable characteristic. The application may obtain the functional relationship from a user input or may be adapted to generate the functional relationship from a collection of relationships (such as may be stored in memory accessible by the application) and the measured data. The application is further configured to access a model relating reservoir permeability and skin factor. The application may also be adapted to utilize the accessed model with a selected permeability value (or skin factor value) to generate a corresponding skin factor (or permeability value). The application maybe further configured to utilize the functional relationship and the measured data to test the validity of the selected permeability value and the corresponding skin factor. The application then will generate a validated permeability value and a corresponding validated skin factor by repeating the steps of utilizing the model and testing the validity of the model results. The validated permeability value and skin factor may be identified when the functional relationship is at least substantially satisfied. In some implementations, the computing power and the application may enable sufficient iterations to justify tight convergence criteria, in other implementations wider convergence criteria may be acceptable. Finally, the application may be adapted to report the validated permeability value and the validated skin factor.

As described above, the systems may be adapted to perform any one or more of the application steps on one or more computing systems. For example, the application itself may be distributed across computing devices with one device establishing the functional relationship and another device utilizing the model. The systems of the present disclosure may be adapted to perform any one or more of the methods described herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. A method comprising:
a) obtaining non-transient well data regarding at least one measurable characteristic of a well;
b) establishing a functional relationship between a reservoir property, a near-wellbore/completion characteristic, and at least one measurable characteristic of the well;
c) accessing a model that relates the reservoir property and the near-wellbore/completion characteristic;
d) utilizing the model with a selected value for one of the reservoir property or the near-wellbore/completion characteristic to generate a corresponding modeled value for the other of the reservoir property or the near-wellbore/completion characteristic;
e) testing the selected value and the corresponding modeled value against the well data using the functional relationship;
f) repeating steps (d) and (e) using distinct selected values until a validated reservoir property value and a validated near-wellbore/completion characteristic value are identified that at least substantially satisfy the functional relationship; and
g) reporting the validated reservoir property value and the validated near-wellbore/completion characteristic for use in business decisions regarding one or more wells.

2. The method of claim 1, wherein establishing a functional relationship comprises selecting a template inflow equation based at least in part on the well data and fitting the template inflow equation to the well data.

3. The method of claim 2 wherein the template inflow equation is a transient inflow equation.

4. The method of claim 1, wherein the reservoir property is reservoir permeability and wherein the near-wellbore/completion characteristic is skin factor.

5. The method of claim 4, wherein the functional relationship relates reservoir permeability, skin factor, reservoir pressures, and production rates, and wherein the model relates reservoir permeability and skin factor.

6. The method of claim 4, wherein the selected value utilized in the model is a selected permeability value; wherein the modeled value is a modeled skin factor value; wherein steps (d) through (f) are repeated to produce a validated permeability value and a validated skin factor value.

7. The method of claim 1, wherein the selected value utilized in the model is a selected permeability value, and wherein the selected permeability value first utilized in the model is based at least in part on one or more of a production log, an open hole log, and a drilling log.

8. The method of claim 7, wherein the distinct selected values used in repeating step (d) are based at least in part on past selected permeability values, results of prior iterations of step (e), or a combination thereof.

9. The method of claim 1, wherein the well data reveals the well has a producing interval comprising two or more layers, wherein a functional relationship is established for each of the layers, wherein at least steps (d) through (f) are implemented for each of the layers, and wherein a validated reservoir property and a validated near-wellbore/completion characteristic is reported for each of the layers.

10. The method of claim 9, wherein distinct models are accessed for at least two of the layers.

11. The method of claim 1 wherein the model is a physics-based model.

12. The method of claim 1 wherein the step of accessing a model comprises developing a model, and wherein the method further comprises updating the model based at least in part on the results of steps (d) through (f) if either the validated reservoir property value or the validated near-wellbore/completion characteristic value are determined to be unreasonable.

13. A method comprising:
a) obtaining non-transient wellbore pressures and production rates along a producing interval of a well;
b) selecting an inflow equation to describe a relationship between the pressures and production rates in the producing interval, wherein the inflow equation relates at least wellbore pressure, production rate, a reservoir property, and a near-wellbore/completion characteristic;
c) accessing a model that relates the reservoir property and the near-wellbore/completion characteristic;
d) utilizing the model with a selected reservoir property value to generate a corresponding near-wellbore/completion characteristic value;
e) using the inflow equation, the selected reservoir property value, the corresponding near-wellbore/completion characteristic value, and the obtained pressures and rates to determine whether the selected reservoir property value and the corresponding near-wellbore/completion characteristic value at least substantially satisfy the inflow equation;
f) repeating steps (d) and (e) with a distinct reservoir property value until the inflow equation is at least substantially satisfied establishing a validated reservoir property value and a corresponding validated near-wellbore/completion characteristic value; and
g) reporting the validated reservoir property value and the corresponding validated near-wellbore/completion characteristic value for use in business decisions regarding one or more wells.

14. The method of claim 13 wherein the wellbore pressures and production rates are obtained from a production log.

15. The method of claim 13 wherein selecting an inflow equation comprises selecting a template inflow equation based at least in part on the obtained pressures and rates and fitting the template inflow equation to the obtained pressures and rates.

16. The method of claim 15 wherein the template inflow equation is a transient inflow equation.

17. The method of claim 13 wherein the model is a physics-based model.

18. The method of claim 13 wherein the producing interval comprises two or more layers; wherein wellbore pressures and production rates are obtained for each of the layers; wherein an inflow equation is selected for each of the layers; wherein at least steps (d) through (f) are repeated for each layer; and wherein a validated reservoir property value and a validated near-wellbore/completion characteristic value are reported for each layer.

19. The method of claim 18 wherein distinct models are accessed for at least two of the layers.

20. The method of claim 13 wherein the reservoir property is permeability and the near-wellbore/completion characteristic is skin factor.

21. A method comprising:
a) obtaining production log data including wellbore pressures and production rates at one or more specific point(s) in time along a producing interval of a well for at least one flowing rate and for a shut-in condition;
b) selecting an inflow equation to describe a functional relationship between the pressures and production rates in the producing interval, wherein the inflow equation relates at least wellbore pressures, production rates, reservoir permeability, and skin factor;
c) accessing a model that relates the reservoir permeability and the skin factor;
d) utilizing the model with a selected permeability value to generate a corresponding modeled skin factor;
e) testing the selected permeability value and the corresponding modeled skin factor against the obtained pressures and rates using the inflow equation;
f) repeating steps (d) and (e) with a distinct selected permeability value until the inflow equation is at least substantially satisfied with a selected permeability value and a corresponding skin factor establishing a validated permeability value and a validated modeled skin factor;
g) reporting the validated permeability value and the validated modeled skin factor for use in business decisions regarding one or more wells; and
h) producing hydrocarbons from the one or more wells.

22. The method of claim 21, wherein the producing interval comprises at least two layers; wherein the production log data includes data for wellbore pressures and production rates in each layer; wherein a corresponding inflow equation is selected for each layer; and wherein at least steps (d) through (g) are implemented for each layer.

23. A system for isolating reservoir properties from near-wellbore/completion characteristics, the system comprising:
a processor;
a memory coupled to the processor;
an application accessible by the processor, wherein the application is configured to:
a) obtain a functional relationship between reservoir permeability, skin factor, and at least one measurable characteristic of a well;
b) receive measured data related to the at least one measurable characteristic;
c) access a model relating reservoir permeability and skin factor;
d) utilize the model with a selected permeability value to generate a corresponding skin factor;
e) utilize the functional relationship and the measured data to test the validity of the selected permeability value and the corresponding skin factor in light of the measured data;
f) generate a validated permeability value and a corresponding validated skin factor by repeating steps (d) and (e) until the functional relationship is at least substantially satisfied with a selected permeability value and a corresponding skin factor; and
g) report the validated permeability value and the corresponding validated skin factor.
